(19) United States
(12) Patent Application Publication
(10) Pub. No.: US 2025/0023515 A1
(43) Pub. Date: Jan. 16, 2025

(54) METHOD AND SYSTEM FOR RESHAPING OF CURRENT-VOLTAGE CURVES IN ORGANIC PHOTOVOLTAIC DEVICES

(71) Applicant: Ubiquitous Energy, Inc., Redwood City, CA (US)

(72) Inventors: Benjamin Wang, Saratoga, CA (US); Ian Millard, Palo Alto, CA (US)

(73) Assignee: Ubiquitous Energy, Inc., Redwood City, CA (US)

(21) Appl. No.: 18/763,264

(22) Filed: Jul. 3, 2024

Related U.S. Application Data
(60) Provisional application No. 63/525,793, filed on Jul. 10, 2023.

(51) Int. Cl. H02S 50/10; G05F 1/67; H02S 20/22; H02S 40/32

(52) U.S. Cl. CPC H02S 50/10; G05F 1/67; H02S 20/22; H02S 40/32

(57) ABSTRACT

Systems and method for reshaping current-voltage (I-V) curves are provided. A photovoltaic system is exposed to a light source. The photovoltaic system includes one or more photovoltaic modules configured to generate electric energy from light incident on the one or more photovoltaic modules. The one or more photovoltaic modules can include thin-film organic photovoltaic layers disposed on glass units of windows. An output voltage of each photovoltaic module is converted up or down to a converted voltage via a fixed ratio converter. The I-V curve of the photovoltaic module is reshaped based on the converted voltage and corresponding converted current. The maximum power point of the photovoltaic module can be tracked based on the reshaped I-V curve.

### CROSS-REFERENCES TO RELATED APPLICATIONS

This application claims priority to U.S. Provisional Patent Application No. 63/525,793, filed Jul. 10, 2023, the disclosure of which is hereby incorporated by reference in its entirety for all purposes.

### BACKGROUND OF THE INVENTION

Photovoltaic (PV) devices are commonly employed to convert light into electricity by using the PV effect, in which absorbed light causes the excitation of an electron or other charge carrier to a higher-energy state. The separation of charge carriers of opposite types leads to a voltage that can be utilized by an external circuit. PV devices, such as PV solar cells, can be packaged together to constitute a PV array of a larger PV system, such as a solar panel. The use of PV systems to generate electricity is an important form of renewable energy that is becoming a mainstream electricity source worldwide.

The surface area necessary to take advantage of solar energy remains an obstacle to offsetting a significant portion of non-renewable energy consumption. For this reason, low-cost, transparent, organic photovoltaic (OPV) devices that can be integrated onto window panes in homes, skyscrapers, and automobiles are desirable. For example, window glass utilized in automobiles and architecture is typically 70-80% and 40-80% transmissive, respectively, to the visible spectrum, e.g., light with wavelengths from about 450 to 650 nm. The low mechanical flexibility, high module cost and, more importantly, the band-like absorption of inorganic semiconductors limit their potential utility to transparent solar cells.

In contrast to inorganic semiconductors, the optical characteristics of organic and molecular semiconductors result in absorption spectra that are highly structured with absorption minima and maxima that are uniquely distinct from the band absorption of their inorganic counterparts. However, while a variety of organic and molecular semiconductors exist, many exhibit strong absorption in the visible spectrum and thus are not optimal for use in window glass-based photovoltaics. Systems, methods, and device structures in the field of transparent solar technology have been improved for use in window glass-based photovoltaics. However, window glass-based photovoltaics pose unique challenges for controlling and regulating generated electric power.

### SUMMARY OF THE INVENTION

The present disclosure relates generally to methods and systems for operating OPV systems. More specifically, the present disclosure relates to systems and methods for reshaping current-voltage (I-V) curves of OPV windows.

According to an embodiment of the present disclosure, an OPV window is provided. The OPV window includes a thin-film OPV layer disposed on a glass unit. The thin-film OPV layer is configured to generate electric power from light incident on the OPV window. The electric power can be characterized by an output voltage and an output current of the thin-film OPV layer. The OPV system also includes a fixed ratio converter connected to the thin-film OPV layer of the OPV window. The fixed ratio converter is configured to convert the output voltage to a converted voltage. Correspondingly, the output current is converted to a converted current. Thus, the I-V curve can be reshaped so that off-the-shelf (OTS) power electronics-based controllers can be used for controlling and regulating the electric power generated by the thin-film OPV layer of the OPV window. The OPV system also includes a controller configured to track a maximum power point for the OPV system.

According to an embodiment of the present disclosure, a photovoltaic (PV) window is provided. The PV window includes a thin-film PV layer disposed on a glass unit. The thin-film PV layer is configured to generate electric power from light incident on the PV window. The electric power is characterized by an output voltage. The PV window also includes a fixed ratio converter connected to the thin-film PV layer. The fixed ratio converter is configured to convert the output voltage to a converted voltage greater than the output voltage.

According to an embodiment of the present disclosure, an OPV system is provided. The OPV system includes multiple OPV windows, multiple fixed ratio converters, and multiple controllers. Each of the multiple OPV windows includes a thin-film OPV layer disposed on a glass unit. The thin-film OPV layer is connected to a corresponding fixed ratio converter. The thin-film OPV layer is configured to generate electric power from light incident on the OPV window. The electric power is characterized by an output voltage. Each of the multiple controllers is configured to track a maximum power point for a corresponding OPV window.

According to an embodiment of the present disclosure, a method for operating an OPV system is provided. The OPV system includes one or more OPV windows. Each OPV window is exposed to a light source. The OPV window includes a thin-film OPV layer disposed on a glass unit. The thin-film OPV layer is configured to generate electric energy from light incident on the OPV window. The electric energy is characterized by an output voltage. The output voltage is converted to a converted voltage via a fixed ratio converter. The I-V curve of the OPV window is reshaped based on the converted voltage and corresponding converted current. The maximum power point of the thin-film OPV layer can be tracked based on the reshaped I-V curve.

According to an embodiment of the present disclosure, a method for operating a PV system is provided. The PV system is exposed to a light source. The PV system includes one or more PV modules configured to generate electric energy from light incident on the one or more PV modules. An output voltage of each PV module is converted to a converted voltage via a fixed ratio converter. The I-V curve of the PV module is reshaped based on the converted voltage and corresponding converted current. The maximum power point of the PV module can be tracked based on the reshaped I-V curve.

Numerous benefits can be achieved by way of the present disclosure over conventional techniques. For example, the output voltage of the thin-film OPV layer on an OPV window can be much larger than conventional silicon PV panels. With the fixed ratio converter stepping down the voltage, OTS power electronics-based controllers that are designed for silicon PV panels can be used for controlling and regulating the electric power generated by the thin-film OPV layer on the OPV window. Thus, embodiments of the present invention obviate the need for customized controllers generally utilized with OPV windows. In other words, the fixed ratio converter makes OTS power electronics agnostic to the different types of PV panels or arrays. In addition, the fixed ratio converter can be integrated into the OPV window and/or the local window frame assembly to reduce exposed voltage (e.g., shocking hazards) and improve safety as well as simplifying installation and providing compliance with safety codes. Meanwhile, the thin-film OPV layer on the OPV window can be maintained as transparent over the full viewable surface without adding any bus bars that would be required for dividing the thin-film OPV layer into different sections to lower the output voltage to accommodate for OTS power electronics-based controllers. Thus, the aesthetics of the OPV window is not affected. These and other embodiments of the disclosure, along with many of its advantages and features, are described in more detail in conjunction with the text below and corresponding figures.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example of a smart home system having various smart windows according to some embodiments.

FIG. 2 illustrates a block diagram of an example smart building system having OPV windows according to some embodiments.

FIG. 3A illustrates a front view of an exterior side of an OPV window having a frame and an IGU according to some embodiments.

FIG. 3B illustrates a front view of an interior side of an OPV window having a frame and IGU according to some embodiments.

FIG. 4 illustrates an OPV window having an IGU according to some embodiments.

FIG. 5 illustrates a process of converting solar energy to electric energy via conventional PV panels according to some embodiments.

FIG. 6 illustrates a process of reshaping the I-V curve via a fixed ratio converter according to some embodiments.

FIG. 7A illustrates a system of multiple OPV windows with reshaped I-V curves by fixed ratio converters according to some embodiments.

FIG. 7B illustrates an array of OPV windows with a reshaped I-V curve by a fixed ratio converter according to some embodiments.

FIG. 8 is a block diagram illustrating an OPV window with a fixed ratio converter providing DC voltage to a load according to some embodiments.

FIG. 9A is an equivalent circuit of an OPV window according to some embodiments.

FIG. 9B is a simplified schematic diagram illustrating a fixed ratio converter connected to the OPV window illustrated in FIG. 9A according to some embodiments.

FIG. 9C is a simplified schematic diagram illustrating a control power circuit providing supply voltage to the half bridge driver 916 in FIG. 9B according to some embodiments.

FIG. 10A illustrates a comparison of the original I-V curve of the OPV window simulated in FIG. 9A and the reshaped I-V curve by a fixed ratio converter in FIG. 9B according to some embodiments.

FIG. 10B illustrates a comparison of the original power curve of the OPV window simulated in FIG. 9A and the reshaped power curve by the fixed ratio converter in FIG. 9B according to some embodiments.

FIG. 11A is a plot of output voltage of the OPV window illustrated in FIG. 9A as a function of time according to an embodiment of the present invention.

FIG. 11B is a plot of voltage Vaux at an auxiliary winding of a transformer according to some embodiments.

FIG. 11C is a plot showing an output voltage of a shunt regulator and currents from sources of a switchable current regulator according to some embodiments.

FIG. 12 illustrates a method of operating an OPV system according to some embodiments.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

The present disclosure relates generally to methods and systems related to generating electric energy using OPV window. More particularly, embodiments of the present invention provide systems and methods for reshaping I-V curves in organic photovoltaic windows. Some embodiments of OPV windows may include the integration of photovoltaics, power electronics, power storage, sensors, and/or a wireless communication system into an insulated glass unit (IGU) and/or a window frame assembly for installation in a home or building. Some embodiments of OPV window may connect to power electronics and power storage devices and provide electric energy to external loads or power grids. While many embodiments are described in reference to windows for use in a home, embodiments are widely applicable to any building or structure in which a window or window-like apparatus may be installed, including various applications in residential, commercial, or industrial settings.

As used herein, the terms “smart window,” “OPV window,” “OPV smart window,” “smart window device,” “smart window system,” and “OPV window system” may be used interchangeably and may generally refer to an apparatus having a visible portion that separates an interior environment from an exterior environment and having one or more of the described components installed therein (e.g., photovoltaics, power electronics, power storage, sensors, wireless communication system, etc.), in accordance with the various embodiments of the present invention.

As used herein, the terms “smart home system,” “smart system,” “home automation system,” “smart building system,” “smart building,” “building automation system,” and “automation system” may be used interchangeably and may generally refer to a wirelessly connected system of a smart window and at least one other device being either another smart window, a smart home hub, a smart building hub, or a user device, in accordance with the various embodiments of the present invention. As such, the above terms may refer to a system having at least two smart windows, a system having at least a single smart window and a smart home hub, a system having at least a single smart window and a smart building hub, or a system having at least a single smart window and a user device, among other possibilities.

As used herein, the terms “smart home hub,” “smart building hub,” “hub device,” “building automation hub,” and “home automation hub” may be used interchangeably and may generally refer to a device (or base station) that exists within the smart home system or the smart building system that is wirelessly connected to at least one smart window and that is capable of receiving data from the smart window and/or transferring data to the smart window, in accordance with various embodiments of the present invention. As used herein, the terms “user device” and “control device” may be used interchangeably and may generally refer to a device that exists within the smart home system that is wirelessly connected to at least one smart window either directly or via the smart home hub or the smart building hub, in accordance with the various embodiments of the present invention.

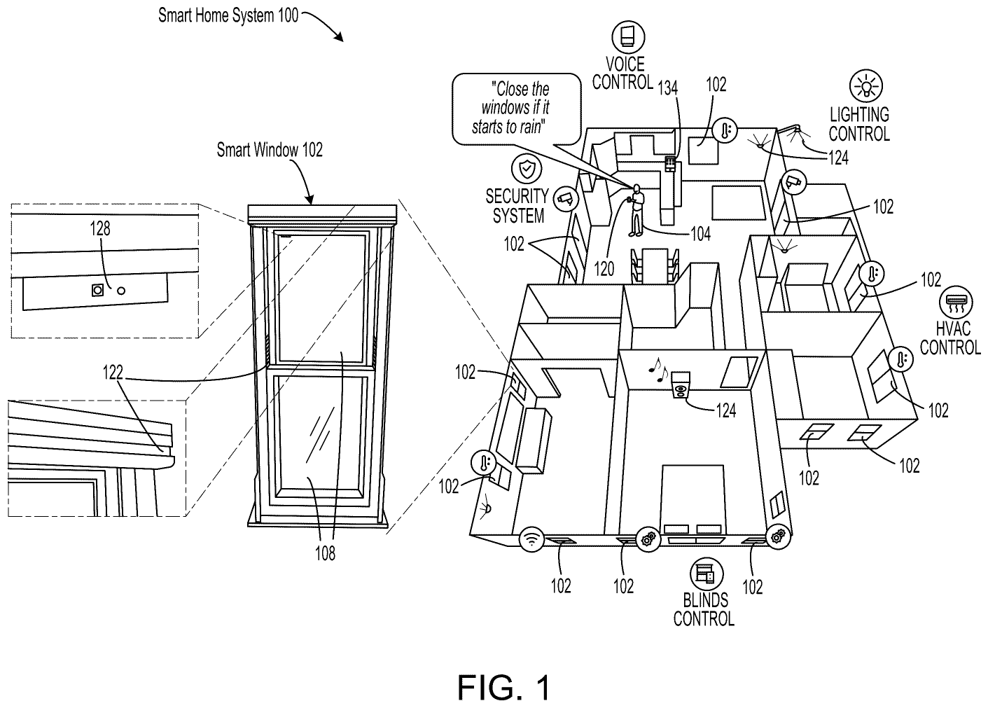

FIG. 1 illustrates an example of a smart home system 100 having various smart windows 102 according to some embodiments. Alternatively, smart home system 100 may be referred to as “home automation system 100” and smart windows 102 may be referred to as “OPV windows 102.” In the illustrated example, smart home system 100 is deployed in a residential house with various rooms, doors, windows, and furniture. Within smart home system 100, smart windows 102 may be communicatively coupled directly to each other or via a smart home hub 134, which in the illustrated example is a device situated on the kitchen countertop and receiving electrical power through the home's electrical system. Further illustrated in FIG. 1 is a user 104 of smart home system 100 holding a user device 120, which in the illustrated example is a mobile phone having an application program (or “app”) installed thereon providing connectivity to smart home system 100.

Each of smart windows 102 may be self-powered using photovoltaics 108 that are integrated with the glass or visible area of the windows. For example, photovoltaics 108 may be integrated with the glass of one or both of the upper and lower panes of a vertical sliding window. Photovoltaics 108 may include organic transparent photovoltaics, luminescent solar concentrators (LSC), or other solar technologies having transparent properties. In some instances, photovoltaics 108 may include a number of visibly transparent OPV devices that absorb optical energy at wavelengths outside the visible wavelength band of 450 nm to 650 nm, for example, while substantially transmitting visible light inside the visible wavelength band. In such embodiments, photovoltaics 108 may be configured to absorb ultraviolet (UV) and/or near-infrared (NIR) wavelengths in the layers and elements of the devices while visible light is transmitted therethrough.

In some embodiments, photovoltaics 108 may be considered to be visibly transparent, at least partially visibly transparent, substantially visibly transparent, and the like. In some embodiments, photovoltaics 108 may be considered to be visibly transparent when they are characterized by an average visible transmittance (AVT) of at least 30%. In various embodiments, photovoltaics 108 may be characterized by an AVT of at least 10%, at least 20%, at least 30%, at least 40%, at least 50%, at least 60%, at least 70%, at least 80%, at least 90%, or approximately 100%.

Each of smart windows 102 may include various electrical loads that are solely powered by photovoltaics 108, without receiving any power from the home's electrical system. For example, smart windows 102 may include various sensors 128 and window functions 122 that are powered by the solar energy harvested by photovoltaics 108. In the illustrated example, sensors 128 include a camera facing the exterior side of the window, which may be used, in some embodiments, as part of the home's security system to monitor and detect movement occurring on the exterior of the home. Further in the illustrated example, window functions 122 include electric blinds that may open (e.g., retract up and/or rotate open) or close (e.g., extend down and/or rotate close) in response to receiving a control signal to do so. Further in the illustrated example, window functions 122 may include an electric mechanism for opening or closing the window (e.g., a motorized track).

Smart home system 100 may include various home functions 124 that are powered separately from smart window 102 using the home's electrical system or some other power source. In the illustrated example, home functions 124 include room lighting and exterior lighting that may be turned on or off (or dimmed) in response to receiving a control signal to do so. Further in the illustrated example, home functions 124 include an audio system that may be turned on or off, or may be controlled in a more specific manner (e.g., to play a particular song at a particular volume, etc.).

User 104 may interact with smart home system 100 and smart windows 102 in a number of ways. For example, user 104 may use an application program running on user device 120 to connect to smart home system 100 to display information about smart windows 102 and/or to transmit control data to modify an operation of smart windows 102. Alternatively or additionally, user 104 may use smart home hub 134 to interact with smart windows 102. For example, in the illustrated example, user 104 provides the audible command “Close the windows if it starts to rain.” This command may be received by a microphone installed on either user device 120 or smart home hub 134. Upon receiving this command, smart home system 100 may create a conditional mapping between data detected by sensors 128 and a window action to be performed by window functions 122 such that smart windows 102 may be caused to close in response to determining by sensors 128 that it is raining on the exterior side of smart windows 102 (e.g., using a camera, moisture sensor, etc.).

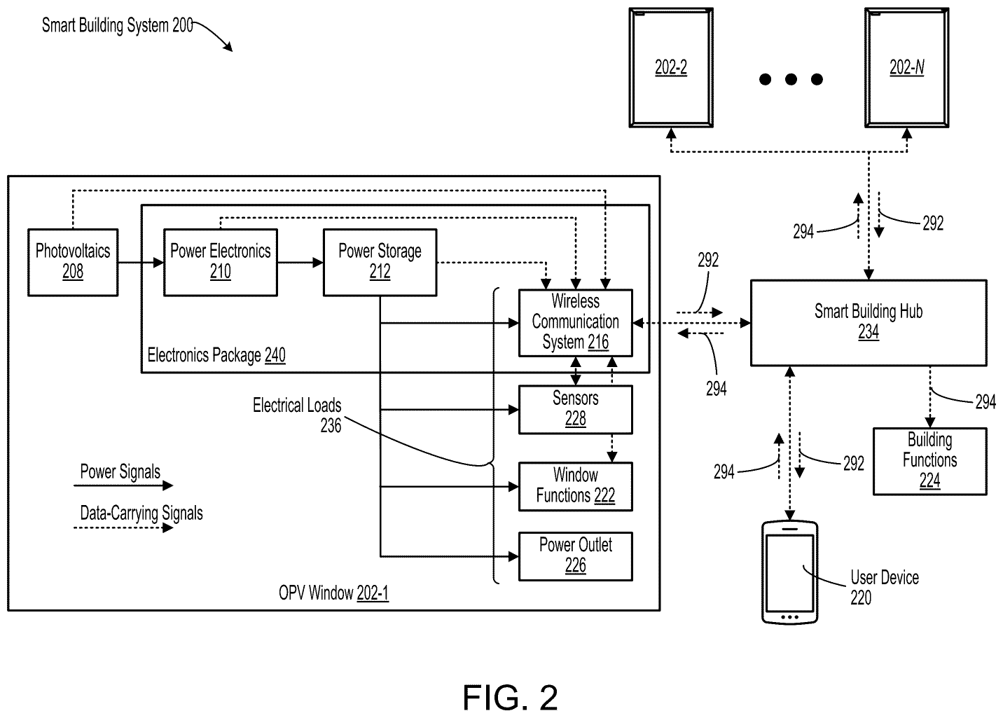

FIG. 2 illustrates a block diagram of an example smart building system 200 having OPV windows according to some embodiments. Smart building system 200 may include one or more (e.g., N) OPV windows 202, which may each be separate, self-contained units capable of being self-powered. In the illustrated example, OPV window 202-1 includes photovoltaics 208, power electronics 210, a power storage 212 (e.g., a battery), and one or more electrical loads 236 (including a wireless communication system 216, sensors 228, window functions 222, and a power outlet 226). OPV windows 202-2 to 202-N may include similar components. Smart building system 200 may further include a smart building hub 234, building functions 224, and a user device 220. The components of smart building system 200 may be interconnected via various power and/or data signals as shown in FIG. 2, with solid lines denoting power signals and dashed lines denoting data-carrying signals, which may include data signals 292, control signals 294, and the like.

In various embodiments, components of smart building system 200 may be more or less integrated than that shown in FIG. 2. For example, in some implementations, power electronics 210, power storage 212, and wireless communication system 216 may be packaged together on a single or multiple circuit boards on what is referred to herein as an electronics package 240. As another example, in some implementations, sensors 228 may include two separate modules, including an exterior sensor module positioned at and/or oriented toward an exterior side of the window and an interior sensor module positioned at and/or oriented toward an interior side of the window.

In some embodiments, photovoltaics 208 may generate and send electrical power to power electronics 210, which can control and regulate the manner, including the voltage and/or current, in which the electrical power is fed into power storage 212. Typically, power storage 212 (which may alternatively be referred to as “energy storage 212”) may include one or more batteries and electronics for power conditioning. In some instances, power electronics 210 is able to maximize the power delivered from photovoltaics 208 to power storage 212 by matching the voltage of photovoltaics 208 to that of power storage 212.

In some embodiments, power electronics 210 conditions the variable output of photovoltaics 208 (variable voltage and current, depending on the lighting) and controls the output to a desired voltage/current acceptable for charging the batteries or powering the various sensors. This may be accomplished using an appropriate combination of buck converters, boost converters, and/or buck/boost converters, along with various active and/or passive circuit components, such as resistors, capacitors, inductors, transistors, transformers, and diodes, among other possibilities. In some instances, power electronics 210 may employ maximum power point tracking (MPPT) which may include adjusting the load to operate close to the maximum power point on the I-V curve of photovoltaics 208, which changes based on lighting condition. Other functions of power electronics 210 include, but are not limited to: managing battery charging/battery draw, conditioning input/output from batteries according to battery specs and safety requirements, and implementing a microcontroller integrated circuit (IC) to run algorithms, such as the MPPT.

The power held by power storage 212 can be used to power each of electrical loads 236. Although FIG. 2 illustrates smart building system 200 as driving all of the powered elements using power from power storage 212, this is not required by the present invention and a combination of power provided directly from photovoltaics 208, directly from power electronics 210, and/or power provided directly from power storage 212 can be utilized to power the various system components. In typical operation, power generated by photovoltaics 208 will be characterized by low current level over an extended period of time while power drawn by devices will be characterized by high current levels for short periods of time. Thus, in some embodiments, power storage 212 may be continually topped off by power delivered through power electronics 210 and may be drained by one or more of electrical loads 236 to meet the power requirements of the various devices.

Each of OPV windows 202 may include a wireless communication system 216 that serves as the wireless interface for communicating between the electronics at OPV windows 202 and external components, such as smart building hub 234, user device 220, and building functions 224. While FIG. 2 shows wireless communication system 216 as communicating with user device 220 indirectly via smart building hub 234, in some embodiments direct wireless communication between wireless communication system 216 and user device 220 may be enabled. Each of wireless communication system 216, smart building hub 234, user device 220, and building functions 224 may comply with one or more wireless standards, including IEEE 802.11 standards, Bluetooth standards, Zigbee standards, 3G, 4G/LTE, WiFi, and the like.

Each of OPV windows 202 may also include one or more sensors 228 for capturing various types of sensor data. Without limitation, sensors 228 may include an interior- and/or exterior-facing camera, an interior- and/or exterior-facing light sensor, an interior- and/or exterior-facing motion sensor, an interior and/or exterior temperature sensor, an interior and/or exterior humidity sensor, an interior and/or exterior accelerometer, an interior and/or exterior contact sensor, an interior and/or exterior audio sensor, an interior and/or exterior moisture sensor, an interior and/or exterior air quality sensor, an interior and/or exterior smoke sensor, a leak sensor for detecting argon or krypton gas leaking from within the IGU, a parts per million (PPM) gas sensor, and the like.

Each of OPV windows 202 may also include one or more window functions 222, which may be devices configured to consume the electrical power generated at the smart window to perform a particular action at the window (or “window action”). Without limitation, window functions 222 may include a window opening/closing mechanism, a window locking/unlocking mechanism, electric blinds, an electrochromic device integrated with the window glass, a polymer-dispersed liquid crystals (PDLC) film, a speaker, a microphone, lighting such as LED strip or edge lighting, a transparent organic light-emitting diode (OLED) display integrated with the window glass, and the like.

As an example operation of OPV window 202 utilizing window functions 222 in conjunction with sensors 228, a light sensor integrated into and powered by OPV window 202 could detect that light over a brightness threshold is passing through the smart window. In order to decrease the light passing through OPV window 202, which could potentially heat up the room in which OPV window 202 is installed, and the home as a result in residential applications, the window shades could be lowered to reduce the light passing through the smart window system and reduce the cooling costs of the home.

Each of OPV windows 202 may also include one or more power outlets 226 for transferring electrical power. For example, power outlet 226 may serve as a port for providing power (e.g., charging) to various devices from power storage 212 or power electronics 210. In some embodiments, power outlet 226 may include a USB receptacle that provides USB charging functionality to various devices. In some embodiments, power outlet 226 can be used to charge the batteries of power storage 212 by connecting an external power source to power outlet 226, thereby causing OPV window 202 to receive electrical power from an external source. In one example, on cloudy days with little sunlight, an external power source (e.g., a portable charger such as a USB power bank) can be connected to power outlet 226 to charge the batteries contained in power storage 212.

In addition to power used to power local sensors 228 and other electrical loads 236, a dedicated power outlet 226 in one of many different form factors can be provided to power window functions 222 or other components installed onto OPV window 202. As an example, a USB outlet can be provided that can provide power to operate window shades that are mounted on OPV window 202.

Data from sensors 228 as well as photovoltaics 208, power electronics 210, and power storage 212 can be used to implement control of the various features and functions described herein. For example, such data may be provided to a central processing unit (CPU) (not shown) of OPV window 202 to be processed to provide control, for example, in conjunction with wireless communication system 216, for the devices implementing the various features and functions described herein. In some embodiments, such data may be sent to smart building hub 234 and/or user device 220 (via wireless communication system 216) in a data signal 292. These devices may receive data signal 292 and may generate control signals 294 to implement the various features and functions described herein.

The above-referenced data that may be included in data signal 292 may include data captured by sensors 228, which may be referred to as “sensor data,” as well as data provided by photovoltaics 208, power electronics 210, and/or power storage 212, which may be referred to as “power data,” which can include data on the state of photovoltaics 208, including current levels, voltage levels, and the like. The power data can then be used to track energy output as a function of time that can be used by various system components. The power data and the sensor data may be analyzed by the onboard processor of OPV window 202, by smart building hub 234, and/or by user device 220. In some instances, smart building hub 234 may receive, through data signal 292, the power data from the batteries of power storage 212 themselves. Such data may indicate a state of charge of the batteries, a charging status of the batteries, or a current output of photovoltaics 208, among other possibilities.

The data received by smart building hub 234 and/or user device 220 can be used to control one or more building functions 224, which may be devices configured to perform particular actions within the building (or “building actions”). Without limitation, building functions 224 may include room lighting, exterior lighting, a building heating system, a building cooling system, building appliances, door locks, audio systems, and the like. Corresponding building actions may include, for example, turning on, off, or dimming the room or exterior lighting, turning on or off the home heating or cooling system, locking or unlocking a door, turning on, off, or controlling the audio system in a more specific manner, and the like.

As an example operation of smart building system 200 utilizing building functions 224 in conjunction with sensors 228, on warm summer days, as the light intensity measured at the smart window system increases or a temperature measured at the smart window system increases (as measured by photovoltaics 208 and/or sensors 228 and communicated to smart building hub 234 via wireless communication system 216), the building cooling system could be turned on in anticipation of increased cooling demand before the temperature in the building begins to increase. Alternatively, if clouds begin to decrease the light intensity or temperature measured at the smart window system, the home cooling system can be turned off in response to this decrease in measured light intensity or temperature, providing additional inputs to the building cooling system that will enable finer control of the building cooling system and resulting reductions in energy consumption. Similar functionality can be provided in relation to a building heating system.

Embodiments of the present invention are applicable to residential window applications and commercial window application. As described herein, power that is generated by the smart window can be utilized by the smart window and by components, for example, window shades, that are mounted on or in proximity of the smart window. Thus, in addition to generating power that can be fed into the power grid and utilized to offset energy consumption in the building that includes smart building system 200, the smart window itself can utilize generated power to power features that are not available in conventional windows. The features that can be provided by embodiments of the present invention span a wide variety of functions, including electrochromic control to modify the tint state of the IGU, surveillance functions enabled by cameras, temperature control functions enabled by temperature sensors, window shade control functions enabled by light sensors, and the like. Thus, smart building systems described herein enable internet-of-things (IoT) functionality without the need to provide power to one or more of the IoT devices.

As described herein, smart window systems are provided that include a number of self-powered features, both interior and exterior, including, but not limited to camera function, motion sensor function, light sensor function, temperature sensor function, humidity sensor function, contact function, for example, intrusion detection using an accelerometer that can alert a user to people or items making contact with the smart window system, communication and indication functions, for example, LED indicators to provide information to a user on the status of various system elements, and the like. Embodiments of the present invention provide functions and features that are not found in conventional windows, because conventional windows do not include a power source that can be used to power devices providing these functions and features. As a result, embodiments of the present invention provide features and functions that can be integrated into a smart window system while also being powered by power generated by the smart window system.

In contrast with a conventional window that would require an external power source to provide these features, the smart window uses power generated by photovoltaics 208 disposed in the IGU. Therefore, the smart window may not need any external wiring, which can result in lack of mechanical integrity, breaking of atmospheric seals, and the like if an attempt to integrate such external wiring into an IGU was attempted. The integration of a power source and sensors 228 inside the IGU enables functionality not available using conventional systems. As an example, in addition to intrusion detection, an accelerometer can be used to detect interaction between a user and the window, including the lites and the frame. Tapping on the lite in accordance with a predetermined pattern could be used to generate sensor data that sends a notification, causes a window action to be performed by a window function 222 (e.g., open a window), or causes a building action to be performed by a building function 224 (e.g., open a lock), and the like.

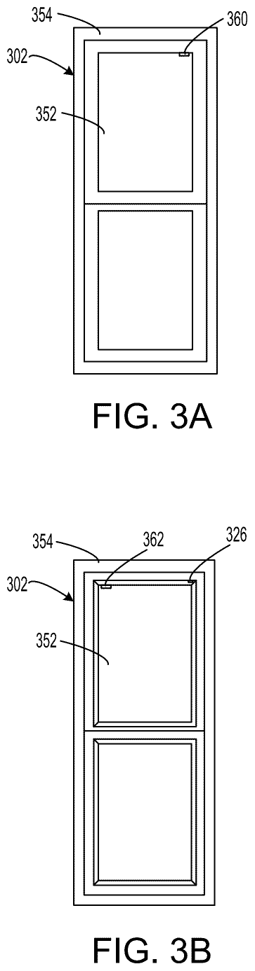

FIG. 3A illustrates a front view of an exterior side of an OPV window 302 having a frame 354 and an IGU 352 according to some embodiments. FIG. 3B illustrates a front view of an interior side of an OPV window 302 having frame 354 and IGU 352 according to some embodiments. In the illustrated examples, OPV window 302 is a vertical sliding window. In other examples, OPV windows can be horizontal sliding windows, fixed windows, or of any other suitable forms. OPV window 302 includes an exterior sensor module 360 that is shown coupled to IGU 352, an interior sensor module 362 that is shown coupled to IGU 352, as well as a power outlet 326, which is a USB-C outlet in the illustrated examples. Each of these sensor modules can include an accelerometer, a temperature sensor, a humidity sensor, a camera, or a light sensor. These sensors are merely exemplary and other sensors and combinations of sensors can be utilized within the scope of the present invention. As described herein, embodiments of the present invention utilize power generated by photovoltaics 208, either directly or via power storage 212 to power various sensors and other electrical loads.

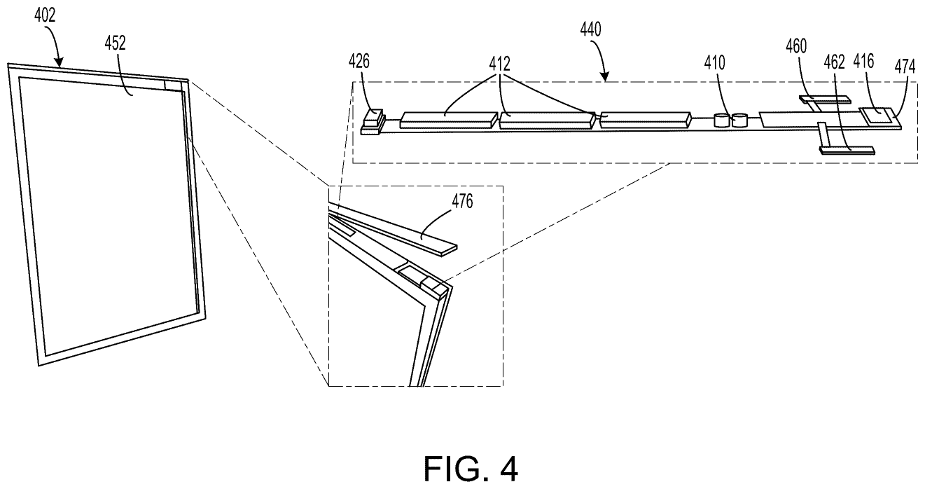

FIG. 4 illustrates an OPV window 402 having an IGU 452 according to some embodiments. FIG. 4 further illustrates (via insets) certain components of OPV window 402 shown separated from IGU 452. In the illustrated example, OPV window 402 includes an electronics package 440 that includes a power outlet 426, power storage 412 (comprising a bank of batteries), power electronics 410, exterior sensor module 460, interior sensor module 462, wireless communication system 416, and OPV input 474. OPV input 474 receives power generated by a thin-film OPV layer of OPV coatings present on the lites. The OPV coatings include OPV cells. Additional description related to OPV coatings is provided in commonly assigned U.S. Patent Publication No. 2019/0036480, the disclosure of which is hereby incorporated by reference in its entirety for all purposes.

In the various embodiments described herein, the term “electronics package” may refer to the group of electrical components contained in the electronics package (e.g., the circuit board and components attached thereto) as well as the casing, packaging, coverings, and/or enclosure in which the group of electrical components are contained. In some implementations, the electronics package can include an enclosure (e.g., a box) with a cover that provides electrical insulation and waterproofing for the electrical components. The cover may further provide access to the electrical components for maintenance and/or replacement of the electrical components.

Electronics package 440 can be implemented on a printed circuit board (PCB) that is mounted in the OPV window. In contrast with conventional windows, embodiments of the present invention integrate power and electronic devices, for example, electronics package 440, inside IGU 452 to provide a self-contained OPV window system that provides both electronic and optical functionality. By integrating the electronics into the IGU, embodiments of the present invention can be utilized with a wide variety of framing systems, typically requiring no modification of the framing system. As a result, the IGU with electronics can be used as a drop-in replacement for conventional IGUs in standard window frames. Therefore, embodiments of the present invention provide augmented IGUs that can include batteries, circuits, sensors, antennas, and the like that can be mounted in standard window frames to form the OPV window system. In the embodiment illustrated in FIG. 4, electronics package 440 is mounted in the upper portion of IGU 452 and is sealed via a cover 476 to provide a controlled environment.

In order to provide for integration with IGU 452, the form factor of electronics package 440 may correspond to the shape of the upper portion of IGU 452, in this case, a width on the order of 10 mm and a length on the order of 50 cm. In various implementations, electronics package 440 may have a wide variety of sizes and form factors. For example, electronics package 440 (or the casing, packaging, or box in which the electronics package is contained) may have a width similar to the width of the IGU's spacer, i.e., between 0.25 to 0.5 inches. In some implementations, electronics package 440 may have a width similar to the width of the entire IGU, i.e., between 0.5 to 1.0 inches. The length of electronics package 440 may be based on the length of the IGU, which may vary from window to window (e.g., 2 feet, 3 feet, 4 feet, etc.).

FIGS. 1-4 illustrate one application of electric energy generated by the OPV windows for powering the functions of the smart windows themselves, such as wireless communication, sensors, window functions, etc. However, the electric energy generated by OPV windows not only can power various smart functions of the windows, but also can be used to power other loads. For example, the electric energy generated by the OPV windows can be provided to other electrical loads within a building or home. In some examples, the electric energy generated by the OPV windows can stored in a power storage device (e.g., batteries). In some examples, the electric energy generated by the OPV window can be provided to electrical loads outside a building or home. In some examples, the OPV windows can be connected to a power grid to provide the generated electric energy to other loads in the power grid.

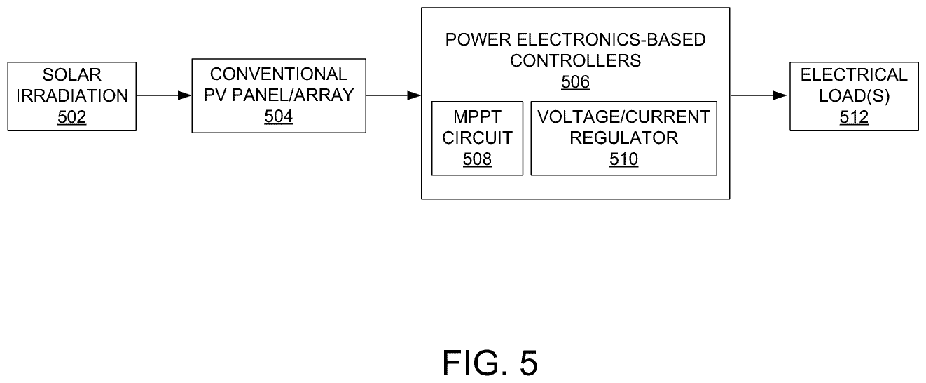

FIG. 5 illustrates a process of converting solar energy to electric energy via conventional PV panels according to some embodiments. The solar irradiation 502 is incident on a conventional PV panel/array 504 (e.g., silicon PV panels) and the conventional PV panel/array 504 can convert the solar energy (e.g., sunlight) to electric energy. The electric energy output by the conventional PV panel/array 504 is usually characterized with variable voltage and current, depending on the solar irradiation 502, which changes throughout the day or based on the weather. The conventional PV panel/array 504 is then connected to power electronics-based controllers 506, which can be included in electronics package 440 as illustrated in FIG. 4.

Power electronics-based controllers 506 can condition and control the variable output of conventional PV panel/array 504 to a desired direct current (DC) or alternate current (AC) voltage/current acceptable for various electrical loads 512. The power electronics-based controllers 506 may include an MPPT circuit 508 that can continuously or periodically adjust the electrical load(s) 512 so that the PV panel/array 504 can operate close to the maximum power point on its I-V curve. The power electronics-based controllers 506 may also include a voltage or current regulator 510 to provide regulated AC or DC power to electrical load(s) 512 downstream. This may be accomplished using an appropriate combination of buck converters, boost converters, and/or buck/boost converters, along with various active and/or passive circuit components, such as resistors, capacitors, inductors, transistors, transformers, and diodes, among other possibilities.

Compared to conventional PV panels (e.g., silicon PV panels), thin film OPV panels typically have higher output voltages and lower currents. As an example, for OPV panels implemented in window applications, one or more panes of the IGU are usually coated with a transparent layer of OPV coatings. The voltage of each window scales with the physical window dimensions. The voltage generated by the transparent layer for an OPV panel, which can be in the range from 200 V to 500 V, is usually higher than that of conventional silicon PV panels, which is usually in the range from 12 V to 60 V. However, most OTS power electronics are designed to accommodate inputs from silicon PV panels and are incompatible with OPV panels due to the higher voltage ratings, current ratings, or both of the OPV panel. Meanwhile, it is not visually appealing to divide the transparent OPV layer into multiple sections and add bus bars in the middle of the windows for connecting these sections in parallel to reduce the output voltage. Thus, to preserve the aesthetics of the OPV windows in commercial buildings or residential houses, it is desirable to step down the output voltage and step up the output current to reshape the I-V curve of the OPV windows so that OTS power electronics can be used to control and regulate the output of the OPV windows. Voltage regulators can step down high voltages of the OPV windows and provide a regulated voltage within the range of downstream power electronics. However, providing a regulated output produces a fixed voltage from the PV panels, making MPPT difficult in downstream power electronics. Thus, the present disclosure provides methods and systems based on the use of a fixed ratio converter to step down the output voltage of the OPV windows.

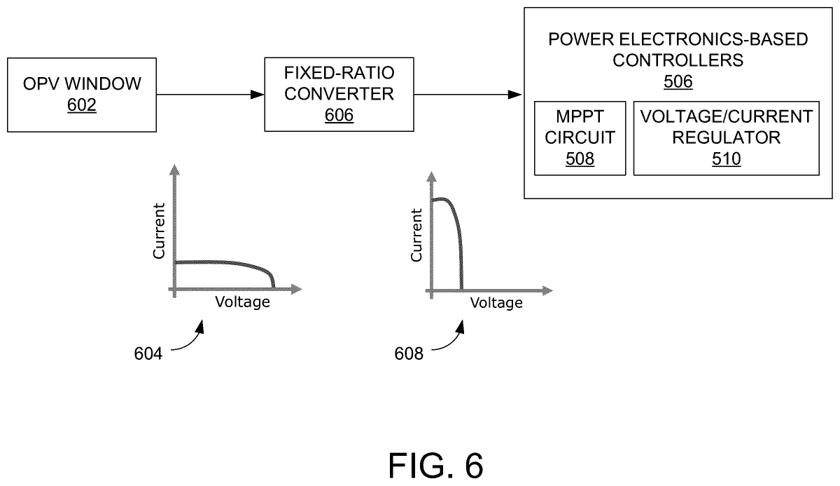

FIG. 6 illustrates a process of reshaping the I-V curve of an OPV window via a fixed ratio converter according to some embodiments. The fixed ratio converter can provide a constant conversion ratio between input and output voltages, and in turn, a constant conversion ratio between input and output currents. In FIG. 6, the output voltage of an OPV window 602 is stepped down by a fixed ratio converter 606. In turn, the output current of the OPV window is stepped up by the fixed ratio converter 606. The inset 604 illustrates the I-V curve corresponding to the output of OPV window 602. This I-V curve is reshaped at the output of fixed ratio converter 606 to the I-V curve illustrated by the inset 608. This reshaped I-V curve is similar to the I-V curve corresponding to the output of conventional silicon PV panels. Thus, OTS power electronics-based controllers 506 can be used for MPPT, power regulation, or other controls. Producing an output corresponding to the shape of the I-V curve of conventional silicon PV panels, based on which OTS power electronics-based controllers are designed, can make downstream OTS MPPT circuits 508 and other OTS power electronics agnostic to the different types of PV panels or arrays.

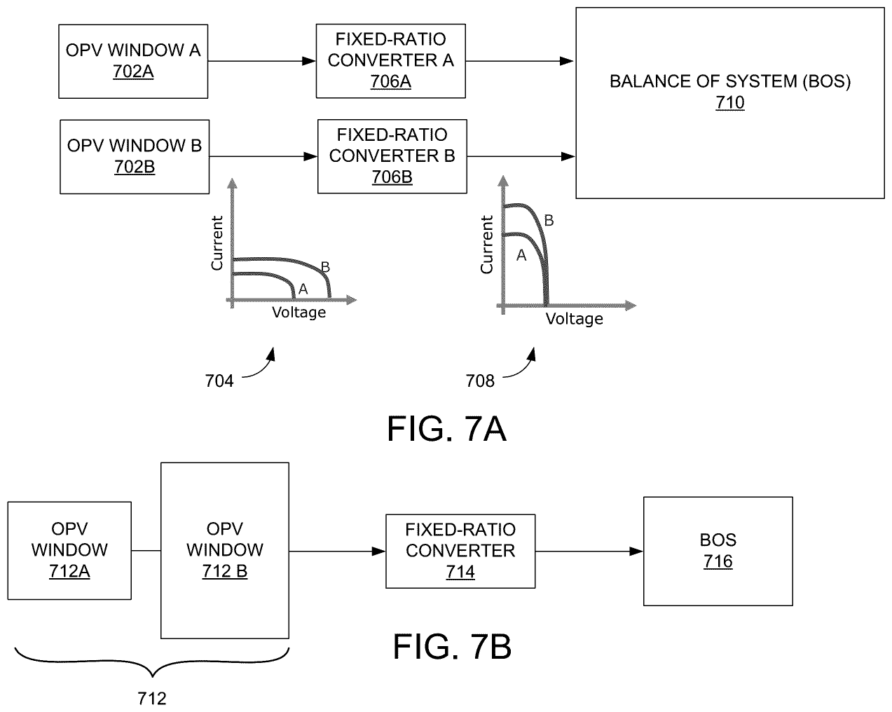

FIG. 7A illustrates a system of multiple OPV windows with reshaped I-V curves by fixed ratio converters according to some embodiments. In addition to high output voltage of individual OPV windows presenting challenges in using OTS power electronics, multiple OPV windows operating at different voltages/currents in the same system can present challenges for creating arrays and standardizing power electronics. In systems that require various PV panels or arrays, different I-V characteristics can be reshaped to similar voltage ranges by one or more fixed ratio converters to simplify design and allow greater standardization of the control system (e.g., balance of system (BOS)). The fixed ratio converter can be customized for corresponding OPV windows and integrated into the corresponding OPV window to reduce exposed voltage (shocking hazards) and improve safety. Additionally, embodiments of the present invention simplify installation and enable compliance with safety codes. In some examples, each OPV window has a control system, including a MPPT circuit and a voltage/current regulator, which can be installed in an electronic package adjacent to each OPV window (e.g., within a few inches). The fixed ratio converter for each OPV window can also be included in the control system. In some examples, multiple OPV windows are connected to one control system installed in an electronic package adjacent to the multiple OPV windows.

In FIG. 7A, OPV window A 702A is connected to fixed ratio converter A 706A and OPV window B 702B is connected to fixed ratio converter B 706B. The inset 704 shows I-V curves corresponding to the output of the two OPV windows: OPV window A 702A and OPV window A 702B. In the illustrated embodiment, OPV window B 702B is larger than OPV window A 702A, so OPV window B 702B has a larger voltage and larger current as shown in inset 704. Thus, fixed ratio converter B 706B utilizes a higher conversion ratio than that of fixed ratio converter B 706B. As a result, the output voltage of fixed ratio converter A 706A can be similar to that of fixed ratio converter B 706B. Inset 708 shows the reshaped I-V curves of the two OPV windows: OPV window A 702A and OPV window A 702B. The outputs of fixed ratio converter 706A and fixed ratio converter 706B can be connected to a BOS 710, which may include MPPT modules and voltage/current regulators. There may be one MPPT module for each OPV window. Alternatively, there may be one MPPT module for multiple OPV windows. In some examples, multiple OPV windows have the same output voltage (e.g., same dimension and same incident solar irradiation), the multiple OPV windows can be connected in parallel to one fixed ratio converter (or multiple fixed ratio converters with the same conversion ratio) before being connected to the BOS. In these examples, the BOS 710 can include one MPPT module connecting to the fixed ratio converter for the multiple OPV windows.

FIG. 7B illustrates an array of OPV windows with a reshaped I-V curve by a fixed ratio converter according to some embodiments. Multiple OPV windows can be connected in an array. The array of OPV windows can have one output voltage, which can be converted by one fixed ratio converter and controlled by managed by one BOS. In FIG. 7B, the OPV window array 712 can include multiple OPV windows 712A, 712B, etc. Each OPV window includes a thin-film OPV layer disposed on a glass unit. The thin-film OPV layer of each OPV window can be connected in an array to form the OPV window array 712. In some examples, the multiple OPV windows or the corresponding thin-film OPV layers have the same size and have the same incident solar irradiance. In these situations, the output voltage of each OPV window can be equal and the output current of each OPV window can also be equal. The multiple OPV windows can be connected in a parallel array or a series array. In some examples, the multiple OPV windows or the corresponding thin-film OPV layers have different sizes, or the incident solar irradiance at some OPV windows is different from that at other OPV windows. Thus, some OPV windows can be connected in parallel and some in series to form an OPV window array including a combination of parallel or series connections. The OPV window array 712 is then connected to a fixed ratio converter 714 for converting up or converting down the output voltage or current of the OPV window array 712. The BOS 716 for the OPV window array 712 can include one MPPT module and one voltage/current regulator.

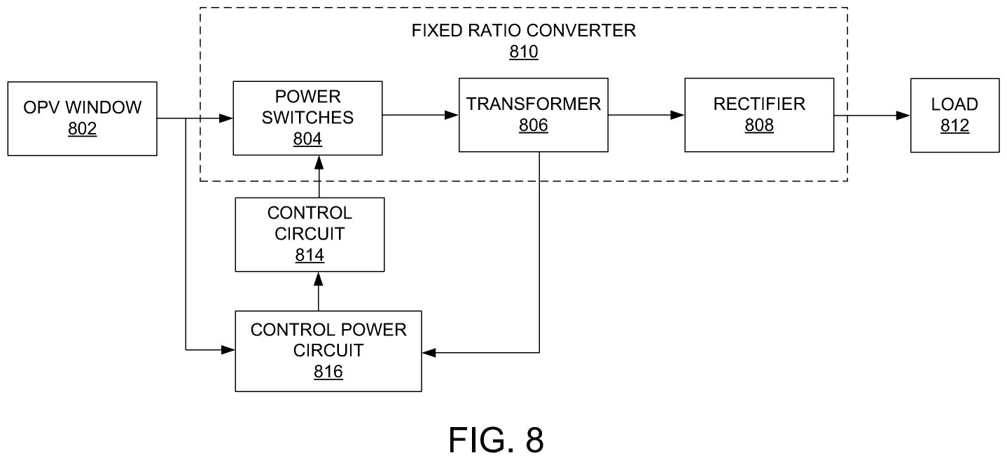

FIG. 8 is a block diagram illustrating an OPV window with a fixed ratio converter providing DC voltage to a load according to some embodiments. The OPV window 802 is connected to fixed ratio converter 810 including a transformer 806, a set of power switches 804, and a rectifier 808. The transformer 806 provides a fixed turns ratio from the primary winding to the second winding, in addition to a galvanic isolation barrier. The primary winding of the transformer 806 is connected to a set of power switches 804. The set of power switches 804 can be in a full bridge (e.g., with four switches) or a half bridge (e.g., with two switches) topology. The set of power switches 804 can be controlled by a control circuitry 814. The control circuitry 814 can be powered by a control power circuit 816, which draws power from the OPV window 802 or an auxiliary winding of the transformer 806. The second winding of the transformer 806 is connected to a rectifier 808, which then provides electric energy to a load 812.

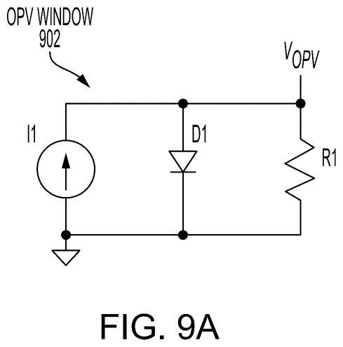

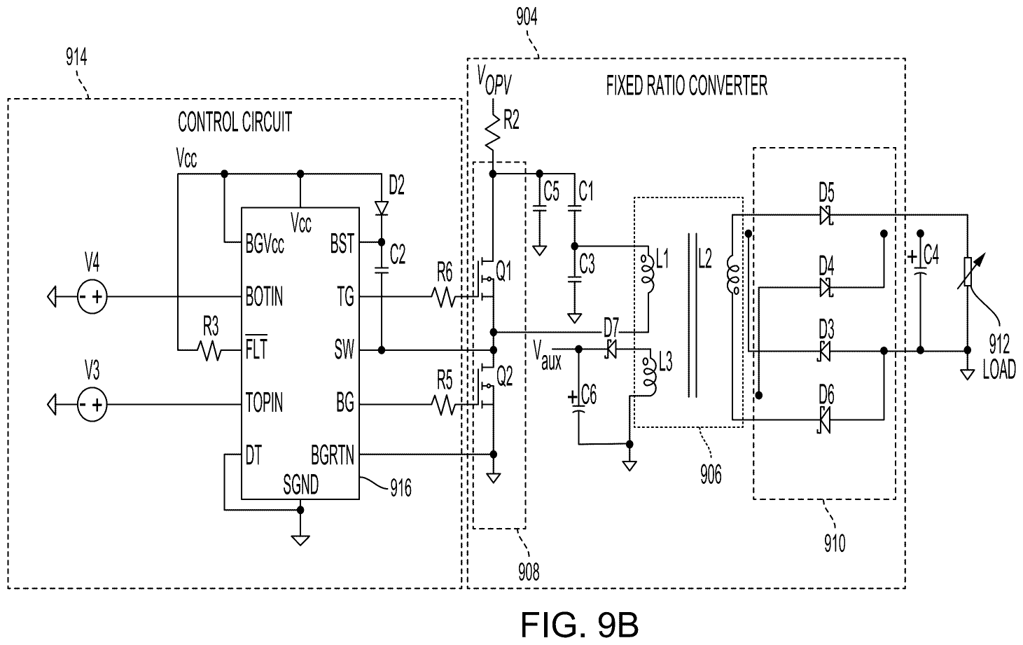

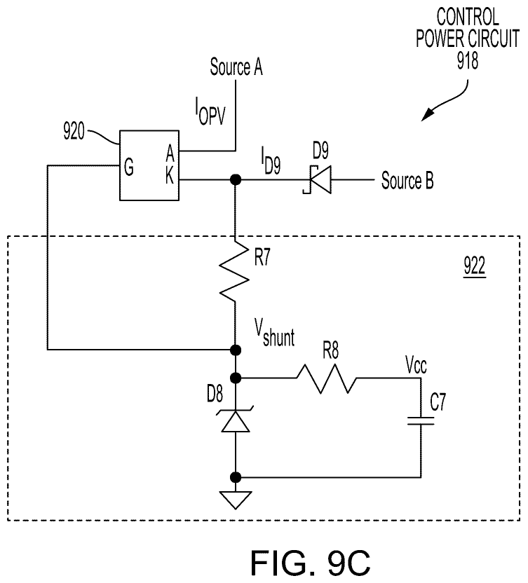

FIG. 9A is an equivalent circuit of an OPV window according to some embodiments. The OPV window 902 is modeled by a current source I1, a diode DI, a shunt resistance R1, and (optionally) a series resistance R2 that is illustrated in FIG. 9B. The output voltage of the OPV window is denoted as V_{OPV}.

FIG. 9B is a simplified schematic diagram illustrating a fixed ratio converter connected to the OPV window illustrated in FIG. 9A according to some embodiments. The fixed ratio converter 904 is implemented as a half bridge isolated DC-DC converter. The fixed ratio converter 904 includes a transformer 906 with primary winding L1, secondary winding L2, and auxiliary winding L3. The primary winding L1 of the transformer 906 is connected to two switches Q1 and Q2 in a half bridge topology 908. In this example, the output of the OPV window V_{OPV} is connected to the half bridge topology 908. The two switches Q1 and Q2 in the half bridge topology 908 are controlled by control circuit 914. The secondary winding L2 of the transformer 906 is connected to a shunt regulator 910 including diodes D3, D4, D5 and D6. The output of the shunt regulator 910 is connected to a load 912, which can be modeled by a piece-wise linear (PWL) resistor.

The control circuit 914 includes a half bridge driver 916. The supply voltage Vcc of the half bridge driver 916 can be provided by a control power circuit 918, as will be described in FIG. 9C. The driver output TG of the half bridge driver 916 is connected to the gate of switch Q1, and the driver output GB of the half bridge driver 916 is connected to the gate of switch Q2.

FIG. 9C is a simplified schematic diagram illustrating a control power circuit 918 providing supply voltage to the half bridge driver 916 in FIG. 9B according to some embodiments. The control power circuit 918 includes a switchable current regulator 920 and a shunt regulator 922. The switchable current regulator 920 is connected to two sources, source A and source B. Source A provides current drawn by a depletion-mode Field-Effect Transistor (FET) (not shown) connected to the output voltage V_{OPV} of the OPV window 902 in FIG. 9A. Source B provides voltage drawn by the auxiliary winding L3 of the transformer 906 in FIG. 9B. The voltage V_{OPV} from the OPV window 902 may sweep from 0 V to 450 V. Source A can keep the control circuit 914 active when the output voltage V_{OPV} of the OPV window is lower or during startup of the OPV window. Source B can power the control circuit 914 when the output voltage V_{OPV} of the OPV window is higher to reduce power dissipation in source A. The shunt regulator 922 includes a resistor R7 and a Zener diode D8. The output of the Zener diode D8 provides supply voltage to the half bridge driver U2 via an LC filter including R8 and C7. In the shunt regulator 922, the series resistor R7 drops the voltage from source B to the Zener diode. The Zener diode D8 takes up the current variations to ensure that the correct drop across the series resistor R7 occurs. Thus, the required supply voltage Vcc is maintained for the half bridge driver 916.

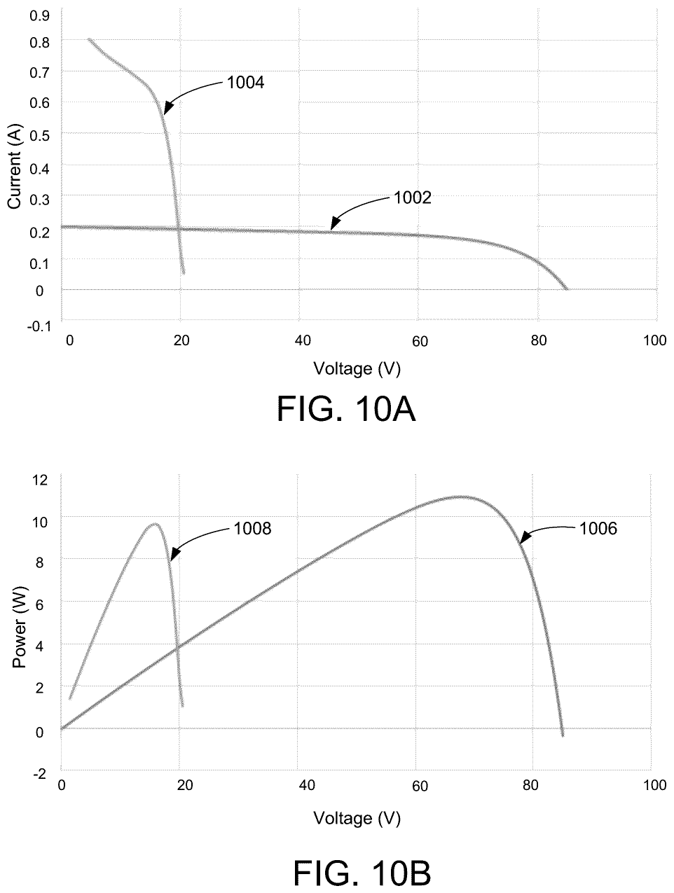

FIG. 10A illustrates a comparison of the original I-V curve of the OPV window simulated in FIG. 9A and the reshaped I-V curve by the fixed ratio converter 904 in FIG. 9B according to some embodiments. Curve 1002 represents the original I-V curve of the OPV window 902 simulated in FIG. 9A. Curve 1004 represents the reshaped I-V curve by the fixed ratio converter 904 in FIG. 9B. The reshaped I-V curve 1004 has a lower maximum voltage and a higher maximum current compared to the original I-V curve represented by curve 1002, because the fixed ratio converter 904 steps down the voltage and steps up the current.

FIG. 10B illustrates a comparison of the original power curve of the OPV window simulated in FIG. 9A and the reshaped power curve by the fixed ratio converter 904 in FIG. 9B according to some embodiments. Curve 1006 represents the original power curve of the OPV window 902 in FIG. 9A. Curve 1008 represents the reshaped power curve by the fixed ratio converter 904 in FIG. 9B. The peaks of curve 1006 and curve 1008 represent the maximum power. The peak of curve 1008 is lower than the peak of curve 1006 because of the power loss at the fixed ratio converter 904 in FIG. 9B and connection lines between the OPV window 902 in FIG. 9A and the fixed ratio converter 904 in FIG. 9B.

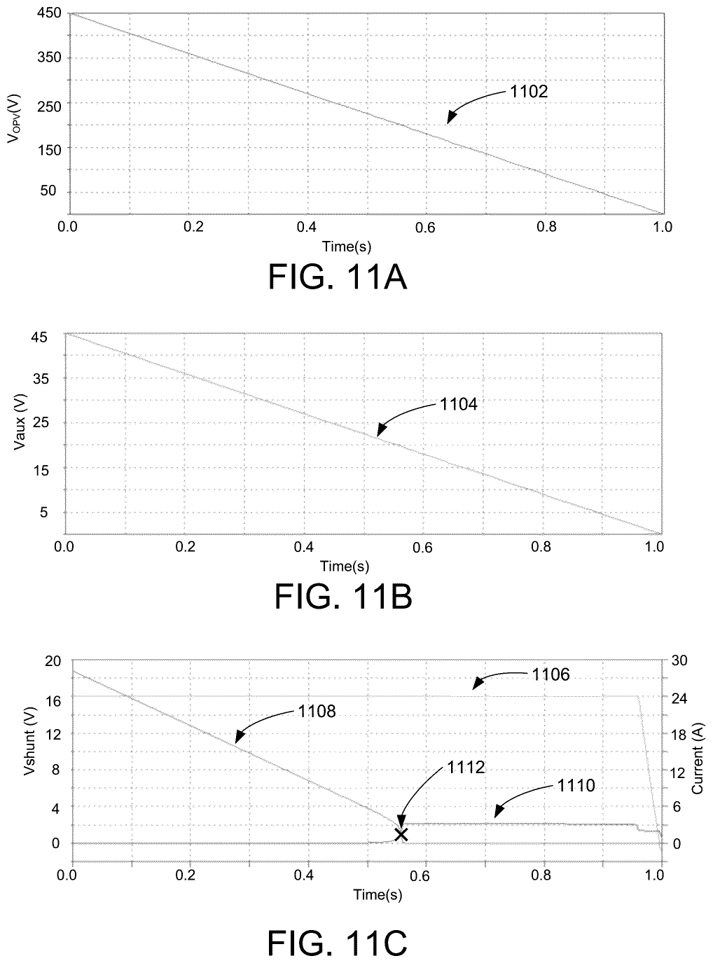

FIG. 11A is a plot of output voltage of the OPV window 902 illustrated in FIG. 9A as a function of time according to an embodiment of the present invention. Line 1102 represents the output voltage V_{OPV} of the OPV window 902 as illustrated in FIG. 9A. FIG. 11A shows that output voltage V_{OPV} sweeps from 450 V to 0 V in 1 second.

FIG. 11B is a plot of voltage Vaux at the auxiliary winding L3 of transformer 906 according to some embodiments. Line 1104 represents the voltage Vₐᵤₓ at the auxiliary winding L3 of the transformer 906 in FIG. 9B. The voltage Vₐᵤₓ at the auxiliary winding L3 of the transformer 906 is a step-down voltage from the voltage at the primary winding L1, which is proportional to the voltage at the OPV window 902. Thus, the voltage Vaux represented by line 1104 ranges from 45 V to 0 V, which is proportional to the output voltage V_{OPV} of the OPV window from 450 V to 0 V represented by line 1102.

FIG. 11C is a plot showing an output voltage Vshunt of the shunt regulator 922 and currents from source A and source B of the switchable current regulator 920 according to some embodiments. Line 1106 represents the output voltage Vₛₕᵤₙₜ of the shunt regulator 922 illustrated in FIG. 9C, which maintains at a stable value as long as the voltage at the OPV window 902 illustrated in FIG. 9A is greater than the voltage across the Zener diode D8 in the shunt regulator 922. Line 1108 represents current I_{D9} drawn from the auxiliary winding L3 of transformer 906 in FIG. 9B. Line 1110 represents current I_{OPV} drawn by a depletion-mode FET from the OPV window 902 illustrated in FIG. 9A. The cross point 1112 of line 1108 and line 1110 represents the transition of the input sources of the shunt regulator 910 in FIG. 9. On the right of the cross point 1112, the output voltage V_{OPV} (represented by line 1102) of the OPV window 902 is smaller; so the source for the shunt regulator 910 is current I_{OPV} (represented by line 1110) drawn by the depletion-mode FET from the OPV window 902. On the left of the cross point 1112, output voltage V_{OPV} (represented by line 1102) of the OPV window 902 is large enough to power up the auxiliary winding L3 of transformer 906; so the source of the shunt regulator 910 becomes the current I_{D9} (represented by line 1108) from the auxiliary winding L3 of the transformer K1.

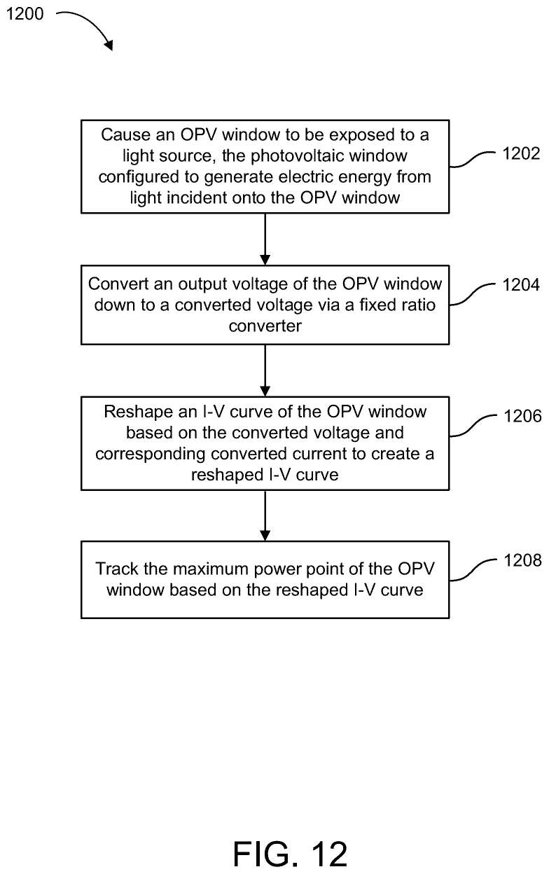

FIG. 12 illustrates a method of operating an OPV system according to some embodiments. For each OPV window of one or more OPV windows of the OPV system, the method 1200 includes causing an OPV window to be exposed to a light source (1202). The OPV window is configured to generate electric energy from light incident on the OPV window. The OPV window includes a thin-film OPV layer disposed on a glass unit. The thin-film OPV layer can include OPV cells connected in series generating electric energy from the incident light. The maximum output voltage of the thin-film OPV layer can be about 450 V.

The method 1200 also includes converting an output voltage of the OPV window down to a second voltage via a fixed ratio converter (1204). The fixed ratio converter can be a half bridge converter including two power switches in a half bridge topology and a transformer with a fixed turns ratio for stepping down the voltage. The two power switches can be controlled by at least one gate driver. The at least one gate driver includes a supply voltage port connected to a shunt regulator powered with at least two sources. The at last two sources comprise a first source providing current drawn by a depletion-mode FET from the OPV window and a second source providing current drawn from the auxiliary winding of the transformer in the fixed ratio converter. If the output voltage of the OPV window is below a predetermined threshold, the shunt regulator is powered by the first source. If the output voltage of the OPV window is at or above the predetermined threshold, the shunt regulator is powered by the second source.

The method 1200 also includes reshaping an I-V curve of the OPV window based on the second voltage to create a reshaped I-V curve (1206). The fixed ratio converter can step down the output voltage of the OPV window from the primary winding of the transformer to the secondary winding of the transformer. Correspondingly, the current of the OPV window can be stepped up. Thus, the I-V curve of the OPV window is reshaped to have a smaller voltage and a higher current so that OTS power electronics-based controllers can be applied to control the electric energy generated by the OPV window.

The method 1200 also includes tracking the maximum power point of the OPV window based on the reshaped I-V curve (1208). With a fixed turns ratio between the primary winding and the secondary winding, if the maximum output voltage of the OPV window can get to around 450 V, the maximum output voltage of the fixed ratio converter can be around 150 V, which still falls in the operational range of OTS power electronics-based controllers, for example MPPT circuits. Correspondingly, the maximum output current of the OPV window can be less than 1 A, and the maximum output current of the OPV window can be less than 3 A. An OTS MPPT circuit can be used to track the maximum power point of the OPV window based on the reshaped I-V curve. The converted voltage or the converted current can be further regulated by a voltage regulator or a current regulator before being provided to an electrical load.

It should be appreciated that the specific steps illustrated in FIG. 12 provide a particular method of operating an OPV system according to an embodiment of the present invention. Other sequences of steps may also be performed according to alternative embodiments. For example, alternative embodiments of the present invention may perform the steps outlined above in a different order. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize many variations, modifications, and alternatives.

Even though the present disclosure describes reshaping the I-V curve of an OPV window using a fixed ratio converter, the present invention does is not limited to applying to OPV windows only. For any photovoltaic modules that convert solar energy to electric energy, their corresponding I-V curves can be reshaped to fit for off-the-shelf (OTS) power electronics-based controllers or for other purposes. The output voltage and output current of the photovoltaic module may be converted up or down based on the specific purpose, but the I-V curve is preserved for MPPT.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a,” “an,” and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An organic photovoltaic (OPV) window comprising:
a thin-film OPV layer disposed on a glass unit, wherein the thin-film OPV layer is configured to generate electric power from light incident on the OPV window, and wherein the electric power is characterized by an output voltage;
a fixed ratio converter connected to the thin-film OPV layer, wherein the fixed ratio converter is configured to convert the output voltage to a converted voltage; and
a controller configured to track a maximum power point for the thin-film OPV layer.

2. The OPV window of claim 1, wherein the converted voltage is less than the output voltage.

3. The OPV window of claim 1, wherein the converted voltage is greater than the output voltage.

4. The OPV window of claim 1, wherein:
a first maximum voltage of the output voltage is about 450 V; and
a second maximum voltage of the converted voltage is less than 150 V.

5. The OPV window of claim 4, wherein the electric power is further characterized by an output current with a first maximum value less than 1 A, wherein the fixed ratio converter is configured to convert the output current to a converted current with a second maximum value about 3 A.

6. The OPV window of claim 1, wherein the thin-film OPV layer comprises multiple OPV cells.

7. The OPV window of claim 1, wherein the thin-film OPV layer comprises a plurality of thin-film OPV cells connected in series.

8. The OPV window of claim 1, wherein the fixed ratio converter comprises a full-bridge converter including four power switches in a full bridge topology and a transformer, wherein the four power switches are controlled by at least one gate driver, wherein the transformer comprises a primary winding, a secondary winding, and an auxiliary winding, and wherein the transformer has a fixed turns ratio between the primary winding and the secondary winding.

9. The OPV window of claim 1, wherein the fixed ratio converter comprises a half bridge converter including two power switches in a half bridge topology and a transformer, wherein the two power switches are controlled by at least one gate driver, wherein the transformer comprises a primary winding, a secondary winding, and an auxiliary winding, and wherein the transformer has a fixed turns ratio between the primary winding and the secondary winding.

10. The OPV window of claim 9, wherein the at least one gate driver comprises a supply voltage portal connected to a shunt regulator powered with a first source and a second source, wherein the first source provides a first current drawn by a depletion-mode field-effect transistor from the thin-film OPV layer, and wherein the second source provides a second current drawn from the auxiliary winding of the transformer in the half bridge converter.

11. The OPV window of claim 10, wherein:
if the output voltage of the thin-film OPV layer at the OPV window is below a predetermined threshold, the shunt regulator is powered by the first source; or
if the output voltage of the thin-film OPV layer at the thin-film OPV layer is at or above the predetermined threshold, the shunt regulator is powered by the second source.

12. The OPV window of claim 1, wherein the fixed ratio converter is located within a frame of the OPV window, and wherein the controller is adjacent to the OPV window.

13. The OPV window of claim 1, wherein the fixed ratio converter and the controller are located adjacent to the OPV window.

14. An organic photovoltaic (OPV) system comprising:
multiple OPV windows;
multiple fixed ratio converters; and
multiple controllers;
wherein each of the multiple OPV windows comprises a thin-film OPV layer disposed on a glass unit, wherein the thin-film OPV layer is connected to a corresponding fixed ratio converter, wherein the thin-film OPV layer is configured to generate electric power from light incident on the OPV window, and wherein the electric power is characterized by an output voltage; and
wherein each of the multiple controllers is configured to track a maximum power point for a corresponding OPV window.

15. The OPV system of claim 14, wherein each of the multiple controllers comprises a maximum power point tracker (MPPT) module and a voltage regulator, wherein each of the multiple controllers is adjacent to the corresponding OPV window.

16. The OPV system of claim 14, further comprising a power storage system configured to store the electric power generated by the multiple OPV windows and provide stored energy to at least one load.

17. The OPV system of claim 14, wherein a first fixed ratio converter connected to a first thin-film OPV layer in a first OPV window is characterized with a conversion ratio determined based on a first maximum voltage of the first OPV window, and wherein a second fixed ratio converter connected to a second thin-film OPV layer in a second OPV window is characterized with a second conversion ratio determined based on a second maximum voltage of the second OPV window.

18. The OPV system of claim 17, wherein the first thin-film OPV layer comprises a first number of OPV cells connected in series, wherein the second thin-film OPV layer comprises a second number of OPV cells connected in series.

19. A method for operating an organic photovoltaic (OPV) system, the method comprising:
for each OPV window of one or more OPV windows of the OPV system:
causing the OPV window to be exposed to a light source, wherein the OPV window comprises a thin-film OPV layer disposed on a glass unit, wherein the thin-film OPV layer is configured to generate electric energy from light incident on the OPV window, wherein the electric energy is characterized by an output voltage;
converting the output voltage to a converted voltage via a fixed ratio converter;
reshaping an I-V curve of the OPV window based on the converted voltage and corresponding converted current to create a reshaped I-V curve; and
tracking a maximum power point of the thin-film OPV layer based on the reshaped I-V curve.

20. The method of claim 19, further comprising regulating the converted voltage via a voltage regulator to generate a stable voltage.
